(19) United States
(12) Patent Application Publication
(10) Pub. No.: US 2012/0279149 A1
(43) Pub. Date: Nov. 8, 2012

(54) System and device for utilization of energy in buildings

(75) Inventor: Sebastian George Quinn, Brooklyn, NY (US)

(73) Assignee: Sebastian George Quinn, Brooklyn, NY (US)

(21) Appl. No.: 13/506,568

(22) Filed: Apr. 30, 2012

Related U.S. Application Data
(60) Provisional application No. 61/518,359, filed on May 4, 2011.

(51) Int. Cl. E04D 13/00; E04D 13/03; E06B 3/00

(52) U.S. Cl. 52/173.1; 52/204.5; 52/200

(57) ABSTRACT

A solar assembly system is provided. The system includes: a building assembly having a window and a panel. The panel is configured operate in a closed or an open position at the interior of the building interior. Further, the panel may extend beyond the window such that an airtight seals forms between the panel and the window.

### CROSS-REFERENCES TO RELATED APPLICATIONS

The present application claims the benefit of U.S. Provisional Application No. 61/518,359, entitled “Solar Energy Device,” filed on May 4, 2011, which is hereby incorporated by reference herein in its entirety.

### FIELD OF THE TECHNOLOGY

The present disclosure generally relates to solar energy devices, more specifically, to utilization of solar energy and day light in buildings.

### DESCRIPTION OF THE RELATED ART

Conventional passive solar design employs glazing to harvest energy from the sun. The energy gained through the glazing process is substantially offset by conductive energy loss when sunlight is not available and by undesired solar energy gains. An example of this is shown by additional heat on hot summer days. Operable systems that are capable of insulating the glazing and blocking solar heat gain, while allowing penetration of daylight can greatly increase the efficiency of passive solar heating and day lighting systems.

These components currently exist for the residential market, and primarily consist of fabric like materials that can be gathered, rolled, or bunched (i.e. curtains, shades, and blinds.) These devices lack the type of durability typically desired for many commercial applications. Thus, it would be desirable, o provide a device and/or system for commercial applications to harvest energy from the sun.

### SUMMARY

In one aspect, a solar assembly system is provided. The system includes: a building assembly having a window and a panel; the panel is configured to operate in a closed or an open position at the interior of the building interior, wherein the panel forms an airtight seal between the panel and the window.

In another aspect, a passive solar glazing device is provided. The device includes: a building assembly having a window and a panel; the panel is configured to operate in a closed position, wherein the panel forms an airtight seal between the panel and the window.

In yet another aspect, an energy device is provided. This device includes a building assembly having a window and a panel; the panel is configured to operate in an open position, wherein the panel forms airtight seal between the panel and the window.

### BRIEF DESCRIPTION OF THE DRAWINGS

The present invention is described in detail below with reference to the attached drawing figures, which are incorporated by reference herein and wherein:

FIG. 1 is a sectional side view of a solar energy device in accordance with an exemplary embodiment of the invention;

FIG. 2 is a frontal view of the solar energy device of FIG. 1;

FIG. 3 is an alternate sectional side view of a solar energy device in accordance with an exemplary embodiment of the invention;

FIG. 4 is frontal view of the solar energy device of FIG. 3;

FIG. 5 is an alternate sectional side view of a solar energy device in accordance with an exemplary embodiment of the invention;

FIG. 6 is an alternate sectional side view of a solar energy device in accordance with an exemplary embodiment of the invention;

FIG. 7 is an alternate sectional side view of a solar energy device in accordance with an exemplary embodiment of the invention; and

FIG. 8 is a sectional edge detail of a solar energy device in accordance with an exemplary embodiment of the invention.

### DETAILED DESCRIPTIONS

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘________’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

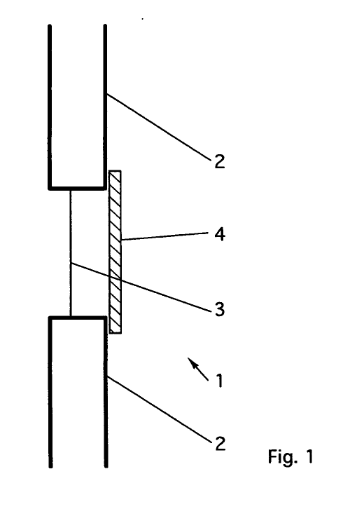

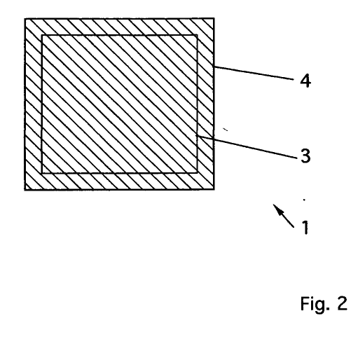

As shown, in FIG. 1 and FIG. 2, there is a solar assembly 1. In some embodiments, the solar assembly 1 may consist of a building assembly 2, with a window 3 and a panel 4. The panel 4 may be located at the interior of the building assembly 1. The panel 4 is operable at this location. Further, FIG. 1 and FIG. 2 show panel 2 in the closed position. As shown in FIG. 2, panel 4 may extend beyond the window 3, so as to allow panel 4 to sit flush against building assembly 2. This may be used to create a relatively airtight sealed space between the panel 4 and the window assembly 3. The term “relatively airtight” is used herein to denote a void space where any gap allowing air infiltration may be between 0 and 12″. In other embodiments, the building assembly 1 may be a wall or a roof assembly, with an angle to vertical between 0 and 90 degrees. Alternatively, the building assembly 1 may be a skylight or light monitor assembly. In another embodiment, the dimensions between window 3 and panel 4 may be between 0.001″ to 20′.

In FIG. 1 and FIG. 2, the panel 4 may be primarily constructed of a translucent material. The translucent material may include plastic, glass, foam, or any composite materials known to those skilled in the art. “Translucent” is used herein to indicate the quality of allowing passage of some, but not all, incident light thru a given material. “Translucent” may indicate light diffusing quality. Examples of possible plastic materials may include single or multiwall polycarbonate, acrylic, polyethylene, or PTFE. Examples of possible glass materials may include single layer, multiple layers, clear or obscured glass sheets. Examples of possible composite materials may include fiberglass/epoxy, carbon fiber/epoxy, or fiberglass/vinyl ester. Panel assemblies may include layers of insulating material such as fiberglass, cellulose, or aerogel. The panel assemblies may range in thickness from 0.05″ to 60″. The panel assemblies may have an R-value between 0.01 and 60, in units of (Square feet *F°* hour/BTU). Further, the various components of panel 4 may be made of various materials as discussed below.

Referring now to FIG. 2, the window 3 and the panel 4 may vary in height from 6″ to 50′ and vary in width from 6″ to 50′. In some embodiments, both the height and width of assembly 1 may be extended further. In one embodiment, the extension may happen by adjoining several window units, or utilizing multiple panels, which may be adjoined or independent from one another. Alternatively, any assembly extension techniques may be used as known by those skilled in the art.

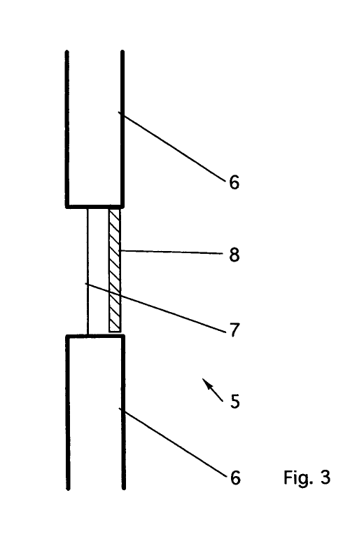

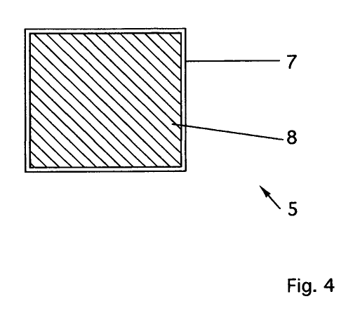

In FIG. 3 and FIG. 4, there is shown an alternate configuration for the solar assembly 5. In some embodiments, the solar assembly 5 may comprise: a building assembly 6, a window 7 and a panel 8. In another embodiment, the panel 8 may be located at the interior of the building assembly 6. In this embodiment, the panel 8 may be operable at this location. Further, FIG. 3 and FIG. 4 show panel 8 in a closed position. As shown in FIG. 3, the panel 8 may fit within a recess surrounding window so as to create a relatively airtight sealed space between the panel 8 and the window 7. In another embodiment, the recessed surround may be integral to window 7, integral to building assembly 6, independent of window 7 and building assembly 6, or a non-operable component of panel 8. The dimension between window 7 and panel 8 (in a closed position) may be within the range 0.001″ to 20′. In some embodiments, the panel 8 may be similar in materials and composition to the panel 4 discussed above. The length and height of window 7 and panel 8 may vary, as discussed above in reference to window 3 and panel 4 in FIG. 2.

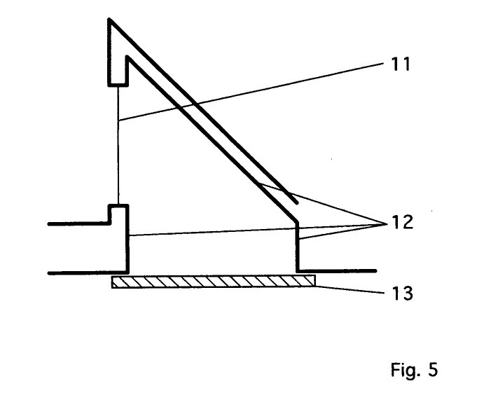

In FIG. 5, there is shown another exemplary embodiment of the solar assembly. The solar assembly 5 may comprise: a window 11, a building assembly 12, and a panel 13. The panel 13 may be located at the interior of building assembly 12. In this embodiment, the panel 13 may be operable at this location. Further, FIG. 5 shows panel 13 in the closed position. This configuration creates a relatively sealed space between the window 11 and the panel 13. The distance between window 11 and panel 13 may be between 0.001″ and 50′. The angle between the plain of window 11 and panel 13 in its closed position may vary from 0 to 270 degrees. In this embodiment, the panel 7 may be similar in materials and composition to panel 4 discussed above. In another embodiment, the building assembly 12 may be a skylight, roof monitor, or clerestory located on, above, or adjacent to a roof with a pitch between zero degrees (horizontal) and ninety degrees (vertical).

In another embodiment, the solar assembly shown in FIG. 5 may utilize an alternate panel location. In this embodiment, panel 13 is replaced with a

panel similar that shown in FIG. 1. In this embodiment, the panel may have the same relationship with window 11 as that between panel 4 and window 3. In this embodiment, the panel may be similar in relative location, materials, composition and size to panel 4 or 8 as discussed above.

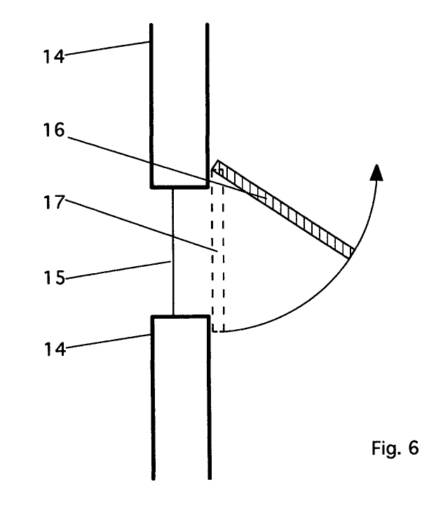

In FIG. 6, there is shown another exemplary configuration of solar assembly 5. In some embodiments, the solar assembly 5 may comprise: a building assembly 14, a window 15, and a panel 16. The panel 16 is shown in an open position, with the panel 16's closed position indicated in panel position 17. The range of operational rotation (from a closed to a fully open position) may vary from 0.01 degrees to 360 degrees. The panel 16 is shown swinging upwards. In another exemplary embodiment, the panel 16 may swing down, sideways (like a residential door), at a diagonal up/sideways, or down/sideways or any manner known to those skilled in the art. The panel 16 may be attached to building assembly 14 with any of several types of hinges including: butt hinges, pivot hinges, strap hinges, piano hinges, European style concealed hinges, or extension hinges. The movement of panel 16 may driven by a manual, simple mechanical, or automated mechanical system. Manual systems may include rope and pulley, hand crank, or chain drive systems. Simple mechanical systems may include, for example, electrically, pneumatically or hydraulically powered chain motors, rack motors or dual rack motors and spindle actuators. Automated mechanical systems may include, for example, mechanical systems activated by light sensors, interior and/or exterior thermometers, timers on a daily cycle, timers on an annual cycle, and internet enable devices accessing weather forecasts and/or climate data. In some embodiments, the panel 16 may be in the closed panel position 17 (insulating the building interior from window 15) whenever the building interior is in heating mode and little or no sunlight is available. Alternatively, the panel 16 may be in closed position 17 whenever the building interior is in cooling mode. In this embodiment, panel 16 may be similar in relative location, materials, composition and size to panel 4 or 8 as discussed above.

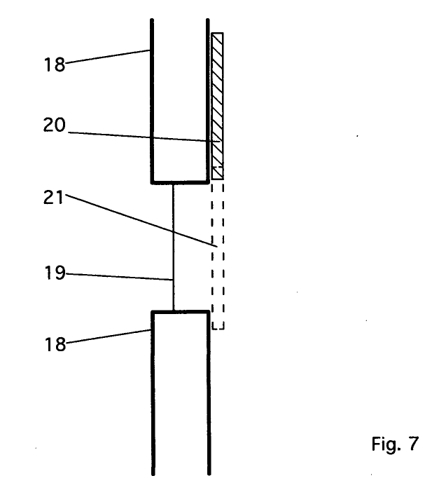

In FIG. 7, there is shown another exemplary configuration of solar assembly 5. In an embodiment, the solar assembly 5 may comprise: a building assembly 18, a window 19, and a panel 20. In some embodiments, the panel 20 may be shown in an open position, with panel 20's closed position indicated in closed panel position 21. The panel 20 is shown sliding upwards. In other possible embodiments, the panel 20 may slide downwards, sideways or in a diagonal fashion. The panel 20 may be mounted on tracks, pistons, guides, or simply hung in place by ropes, cables, or chains. The movement of panel 20 may be actuated similarly to panel 16 described above. In other embodiments, the panel 20 may be similar in relative location, materials, composition and size to panel 4 or 8 as discussed above.

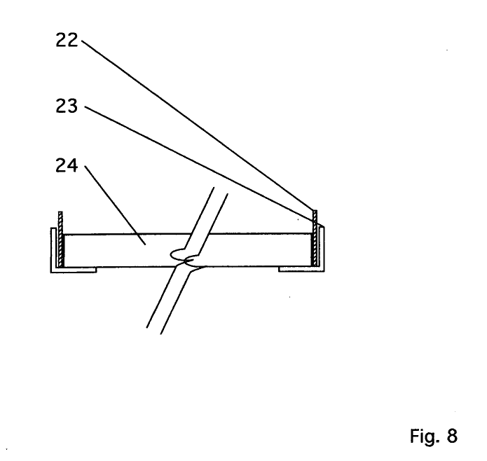

In FIG. 8, an exemplary embodiment of a cross section of panel 4, panel 8, panel 13 or panel 20, is shown. In some embodiments, the panel edge may comprise: a gasket 22, frame 23, and panel material 24. The frame 23 may be made of wood, metal, plastic, or any composite material known to those skilled in the art. The frame 23 may employ the profile section shown, or another section such as a rectangular section, channel section or “I” shaped sectional profile. The panel material 24 may sit within the frame 23, or be biased to either side or offset to either side. The panel material 24 may be primarily constructed of a translucent material such as plastic, glass, foam, or any composite materials known to those skilled in the art. Examples of possible plastic materials may include single or multiple layers, single or multiwall polycarbonate, acrylic, polyethylene, or PTFE. Examples of possible glass materials may include: single or multiple layers of clear or obscured glass sheet. Examples of possible composite materials may include: fiberglass/epoxy, carbon fiber/epoxy, or fiberglass/vinyl ester. The panel assemblies may include layers of insulating material such as fiberglass, cellulose, or aerogel. The panel assemblies may range from 0.05″ to 60″ in width. The panel assemblies may have an R-value between 0.01 and 60, in units of (Square feet *F°* hour/BTU). Any hinges or other mounting hardware may be attached directly to frame 23 or to panel material 24. The panel 24 and frame 23 may be joined by mechanical fasteners, or adhesives. The mechanical fasteners may include screws, bolts, and rivets. The adhesives may include double sided tape, epoxy, or silicone. Alternately, the gasket 22 may be joined to frame 23 so as to hold panel 24 in place between the gasket 22 and the frame 23. The gasket 22 is optional. The gasket 22 may be joined to frame 23 by mechanical fasteners, or adhesives. The mechanical fasteners may include screws, bolts, and rivets. The adhesives may include double sided tape, epoxy, or silicone. When the passive solar device is in a closed position, the frame 23 may be configured so as to form a relatively tight air seal with the adjacent building assembly or window assembly. Alternately, the gasket 22 may be utilized to create the seal described above. The gasket 22, if utilized, may have the cross sectional profile shown, or a bulb, accordion or curved or angled profile. The gasket 22 may be primarily constructed of vinyl, EPDM, neoprene, silicone, PTFE, or Teflon. Further, the various components of gasket 22 may be made of various materials such as metal, fiberglass, or plastic. The solar device illustrated in FIG. 8 is only one possible panel edge detail—the panel material or assembly may, for example, not require a frame, or may, for example, be comprised of several infill panels in a single frame, several panels in several frames, or several panels in several frames within a larger frame. Alternatively, any known solar device configuration and/or arrangement may be used known by those skilled in the art.

Further, the exemplary embodiments of the solar device a may be used in combination with passive solar glazing and/or in combination with glazing designed for day lighting to increase the energy efficiency of passive solar assemblies and/or day lighting assemblies.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

What is claimed is:

1. A solar assembly system, comprising:
a building assembly having a window and a panel;
the panel is configured to operate in a closed or an open position at the interior of the building , wherein the panel forms an airtight seal between the panel and the window.

2. The solar assembly of claim 1, wherein the panel sits flush against the building assembly.

3. The solar assembly of claim 1, wherein the panel is a translucent material.

4. The solar assembly of claim 1, wherein the panel includes layers of insulating material.

5. The solar assembly of claim 1, wherein the building assembly is a skylight.

6. The solar assembly of claim 1, wherein the building assembly is a roof monitor.

7. A passive solar glazing device, comprising:
a building assembly having a window and a panel;
the panel is configured to operate in a closed position, wherein the panel forms an airtight seal between the panel and the window.

8. The passive solar glazing device of claim 7, wherein the panel sits flush against the building assembly.

9. The passive solar glazing device of claim 7, wherein the panel is a translucent material.

10. The passive solar glazing device of claim 7, wherein the panel includes layers of insulating material.

11. The passive solar glazing device of 7, wherein the building assembly is a skylight.

12. The passive solar glazing device of claim 7, wherein the building assembly is a roof monitor.

13. The passive solar glazing device of claim 7, wherein the dimensions between the window and panel range from 0.001″ to 20′.

14. The passive solar glazing device of claim 7, wherein the panel has an R- value between 0.01 and 60.

15. An energy device, comprising:
a building assembly having a window and a panel;
the panel is configured to operate in an open position, wherein the panel forms an airtight seal between the panel and the window.

16. The energy device of claim 15, wherein the panel sits flush against the building assembly.

17. The energy device of claim 15, wherein the panel is a translucent material.

18. The energy device of claim 15, wherein the panel includes layers of insulating material.

19. The energy device of claim 15, wherein the building assembly is a skylight.

20. The energy device of claim 15, wherein the building assembly is a roof monitor.
